(19) United States
(12) Patent Application Publication
(10) Pub. No.: US 2002/0095483 A1
(43) Pub. Date: Jul. 18, 2002

(54) Method of providing washing course programs and self diagnosis service of an automatic washer from a remote server

(75) Inventors: Sang Soo Lee, (US); Gyeong Ho Moon, (US)

Correspondence Address: FLESHNER & KIM, LLP, P.O. Box 221200, Chantilly, VA, 20153-1200, US

(73) Assignee: LG Electronics Inc.

(21) Appl. No.: 09/972,049

(22) Filed: Oct. 9, 2001

(30) Foreign Application Priority Data
Oct. 9, 2000 (KR) 00-59206
Oct. 9, 2000 (KR) 00-59205
Oct. 9, 2000 (KR) 00-59204

(51) Int. Cl. G06F 15/16

(52) U.S. Cl. 709/219; 709/203

(57) ABSTRACT

The present invention relates to a method of providing various washing course programs and/or self diagnosis service for an automatic washer from a remote server located in Internet wherein the automatic washer is connected to a data terminal such as personal computer through a communication cable or has a built-in communication function. With the present invention, it is possible to apply newly-developed various washing course programs to already-sold washing machines with ease, and to prevent damages of clothes, light washing ability, and so on which might be caused from unskilled manipulation to a washing machine, and a user can set and change initial screen displayed onto an LCD panel, animations indicating washing states, messages to deliver to someone through an LCD, melodies as he or she wants.

### BACKGROUND OF THE INVENTION

1. Field of the Invention

The present invention relates to a method of providing various washing course programs and/or self diagnosis service for an automatic washer from a server located in Internet.

2. Description of the Related Art

In general, an automatic washer, one of electric home appliances, requires convenient usage and optimal washing performance adequate to given washing condition, so that a present automatic washer has an internal memory containing various washing course programs such as wool cloth washing program. In various washing course programs, the most appropriate program having optimal washing time, rinsing time, and spinning time is selected based on type of clothes, an amount of clothes, and so on to prevent damages of clothes and to wash the clothes most cleanly.

Therefore, a user can select a desirable washing course program easily from the various ones stored in a washing machine and accomplish an automatic optimal washing process adequate to cloth condition.

In these days, a washing machine has a tendency to equip with a wider LCD panel on a front side than a conventional one, so that a user can acknowledge operational and washing state of a washing machine with ease through a larger LCD.

Lately, clothes made of new materials are developed and life patterns are diversified, which brings about various washing conditions. Therefore, companies manufacturing a washing machine are developing new washing course programs for new washing conditions and is applying them to new products.

In case of applying new-developed washing course programs to already-sold products, an expert after-sale serviceman should visit each house and replace embedded controller and memory with new ones. However, such a work is so time-consuming that it is almost impossible to apply new washing course program to already-sold products.

In addition, an initial screen and an operation-explaining one displayed onto an LCD panel positioned on the front are always shown in accordance with fixed formats, so that they can not satisfy sufficiently user's desire of various selecting views.

In addition, if a user fails to select an optimal washing course program adequate to washing condition including the number of family members, an amount of clothes to wash, washing preference, etc., clothes would be damaged or not be washed cleanly. After this erroneous manipulation, many users frequently question the reason and solution thereof.

### SUMMARY OF THE INVENTION

It is an object of the present invention to provide a method of storing, updating, or executing a washing course program suitable to various washing conditions, a network communication program to receive the washing course program through a data network, initial screen to be displayed onto an LCD, or animations to indicate respective washing states in an automatic washer which is connected to a data terminal through a communication cable or has a built-in communication function.

It is another object of the present invention to provide a method of serving an automatic washer with a washing course program most suitable to user's washing condition such as the number of a user's family, an average amount of clothes to wash, and washing preference, and so on, which are given from the user.

It is another object of the present invention to provide a method of diagnosing state and/or performance of an automatic washer remotely through a data network, informing cause and solution resulted from the diagnosis, and downloading a washing course program suitable to solving the washing problems a user specified.

A method of providing a washing course program from a server according to the present invention, checks whether a pre-determined network communication program has been installed in a subscriber data terminal connected through a data network; advises of an installation of the pre-determined network communication program; downloads the pre-determined network communication program in the basis of the checking result; displays menu screen for selecting a washing course program stored in a database onto a monitor of the subscriber data terminal after executing the downloaded network communication program; and downloads a washing course program chosen from the subscriber data terminal to a washing machine through the subscriber data terminal connected with the washing machine.

Another method of providing a washing course program from a server according to the present invention, examines washing conditions of a subscriber in the basis of subscriber information pre-stored in a database; searches the database for a washing course program suitable to the examined washing conditions; and displays a message requesting download of the found suitable washing course program onto a monitor of a data terminal of the subscriber.

Another method of providing a self diagnosis service from a server according to the present invention, displays menu screen for selecting washing machine diagnosing items for checking machine state and/or performance of subscriber's washing machine onto a monitor of a data terminal connected through a data network; receives one or more items selected among the displayed washing machine diagnosing items through the data terminal; searches a database for a suggestion to solve the chosen items; and displays the found suggestion onto the monitor.

### BRIEF DESCRIPTION OF THE DRAWINGS

The accompanying drawings, which are included to provide a further understanding of the invention, illustrate the preferred embodiments of the invention, and together with the description, serve to explain the principles of the present invention.

In the drawings:

FIG. 1 shows an exemplary network which a method of providing washing course programs and a self diagnosis service in accordance with the present invention is applied to;

FIGS. 2A to 2H show flow charts embodying a washing course program providing method of an Internet server according to the present invention;

FIG. 3 is an example of subscriber information stored in connection with washing machine information;

FIG. 4 shows an example of a home page of an IP server shown according to the present invention;

FIG. 5 shows an example of a login window of an IP server shown according to the present invention;

FIG. 6 shows an example of a download menu page presented by an IP server according to the present invention;

FIG. 7 shows an Internet washing course program selected sub-menu page of an IP server shown according to the present invention;

FIG. 8 shows a favorite washing course program selected sub-menu page of an IP server shown according to the present invention;

FIG. 9 shows an LCD message selected sub-menu page of an IP server shown according to the present invention;

FIG. 10 shows an animation selected sub-menu page of an IP server shown according to the present invention;

FIGS. 11A to 11D show flow charts embodying another washing course program providing method of an Internet server according to the present invention;

FIG. 12 is another example of subscriber information stored in connection with washing machine information;

FIGS. 13A to 13H show flow charts embodying a self washing machine diagnosing method of an Internet server according to the present invention; and

FIGS. 14 to 17 show exemplary menu screens for each step conducted according to diagnosis procedures of the present invention.

### DETAILED DESCRIPTION OF THE PREFFERRED EMBODIMENT

In order that the invention may be fully understood, a preferred embodiment thereof will now be described with reference to the accompanying drawings.

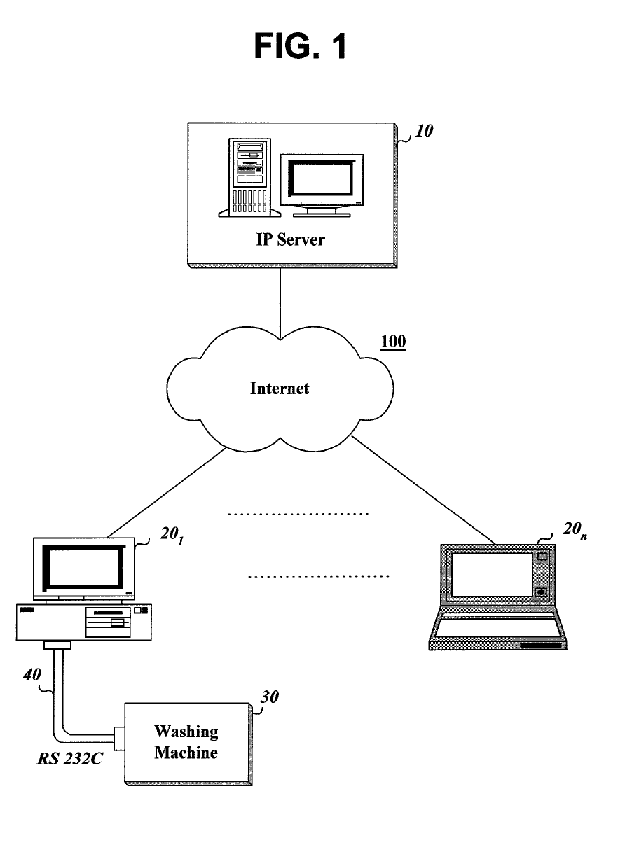

FIG. 1 shows an exemplary network which a method of providing washing course programs and a self diagnosis service from an Internet server in accordance with the present invention is applied to. Included in the network of FIG. 1 are an IP server 10; many personal computers (PCs) 20₁ to 20n connectable to the IP server 10 through Internet 100; and a washing machine 30, located in a house, connected to one 20₁ of the PCs through a communication cable 40 such as RS-232C serial line or modem cable.

The washing machine 30 has an input/output port (not shown) for connection of the cable 40 on its one side or top, otherwise, it has an internal communication module being able to connect to Internet directly.

Therefore, the washing machine 40 is able to communicate with the PC 20₁ through the connected cable 40, and then communicate with the IP server 10, connected to the PC 20₁ through Internet 100, through intermediary communicating device of the PC 20₁.

The PC 20₁ has an Internet operating program (IOP) in its storage device. This IOP can conduct Web browsing function and further can download and update various washing course programs, and graphic data of an initial screen and an operation-explaining screen to be displayed onto a front LCD panel of the washing machine 30, etc. from a database of the IP server 10.

The washing course programs, graphic data of an initial screen and an operation-explaining screen, melody data, text data, and so on received by the IOP are delivered to the connected washing machine 30, and self-diagnosis program to the washing machine 30 is conducted through the IOP running in the PC 20₁.

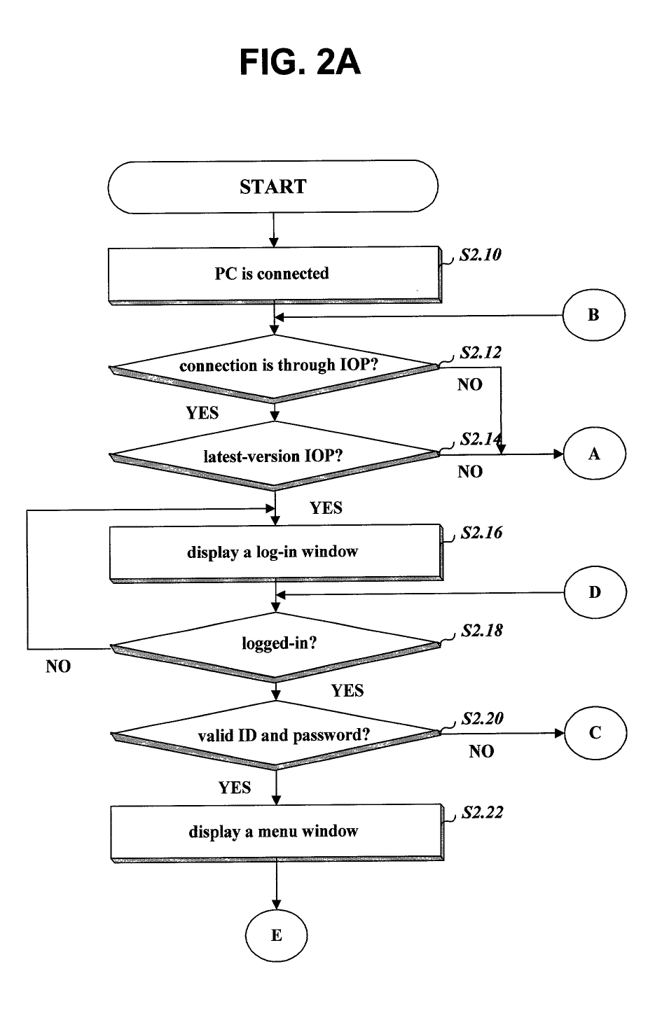

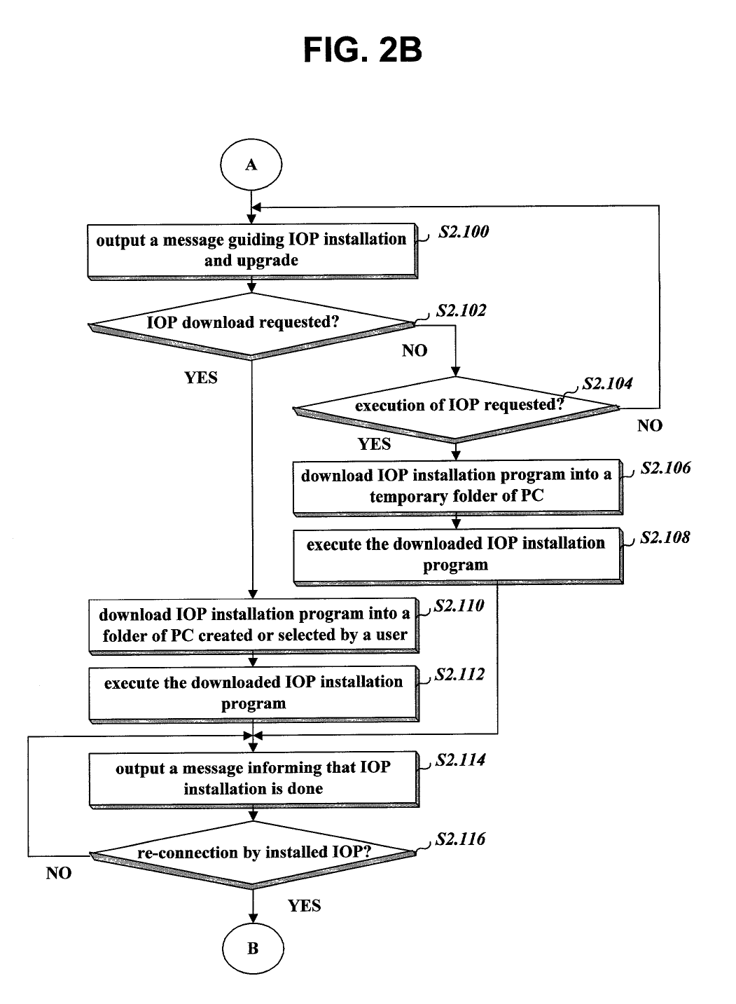

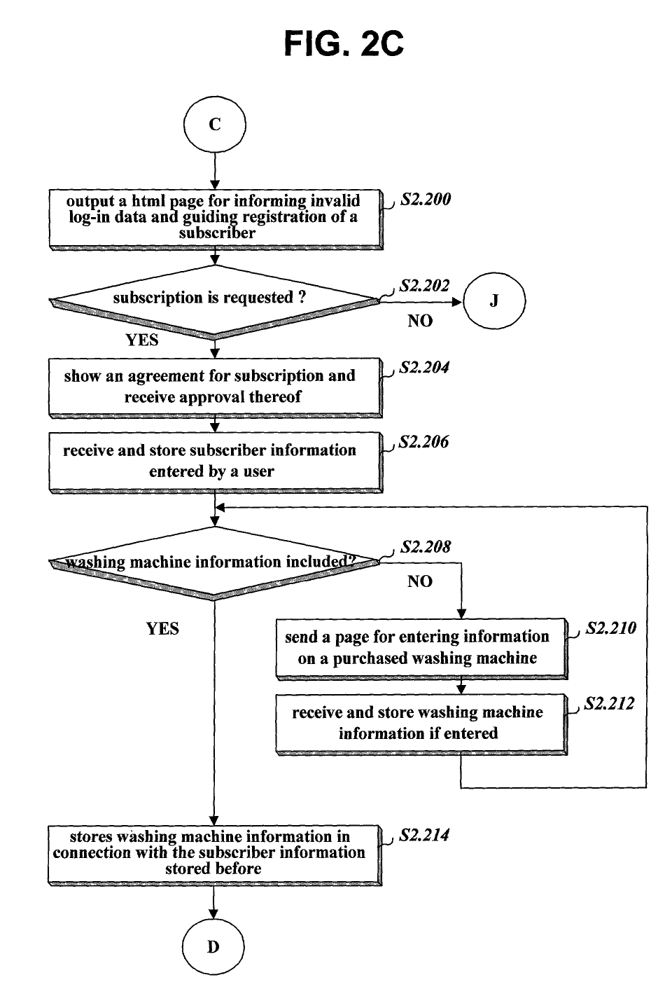

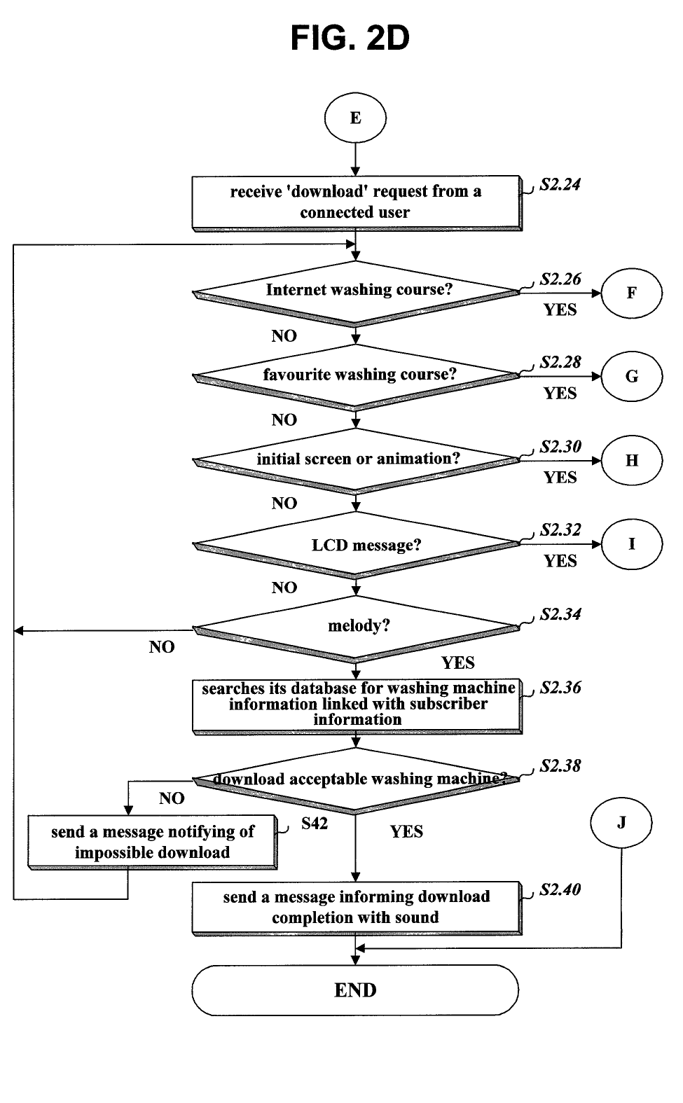

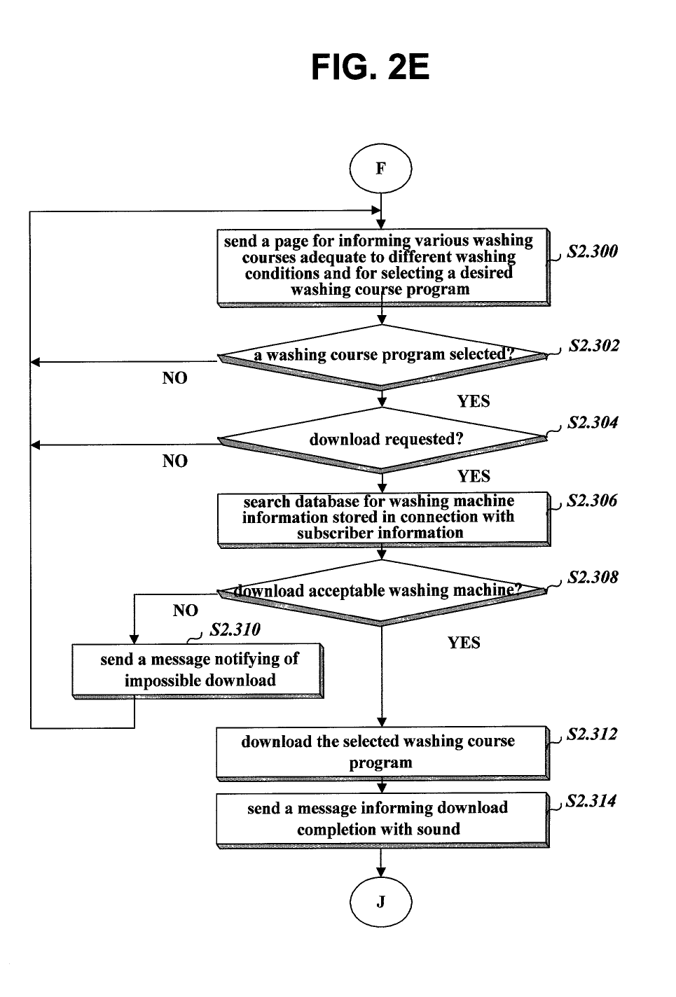

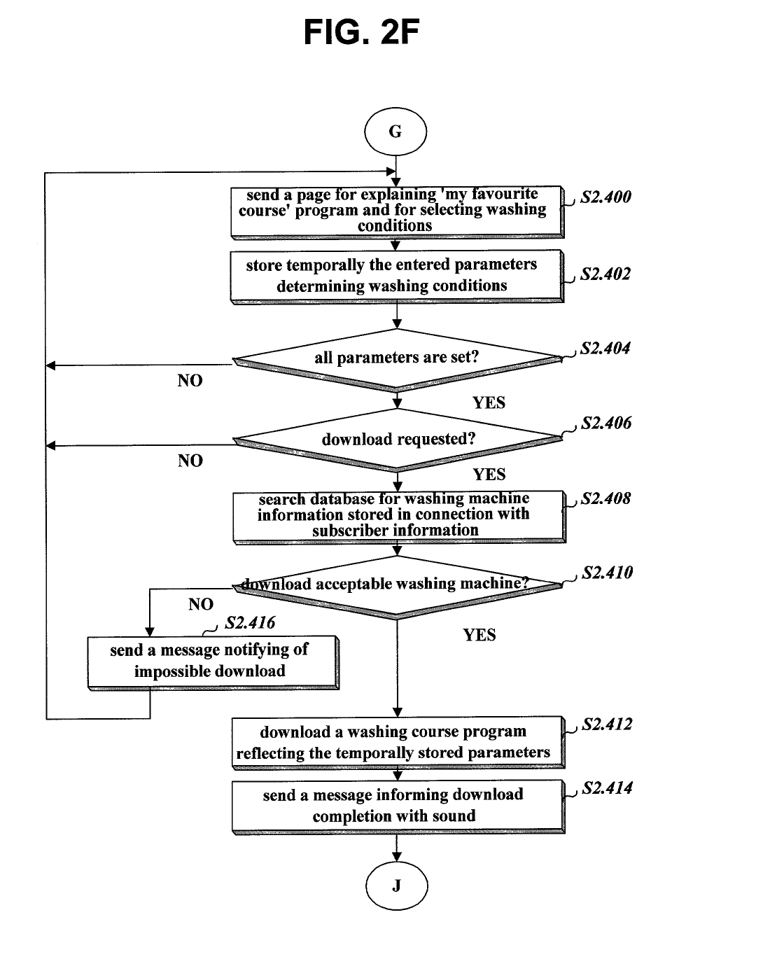

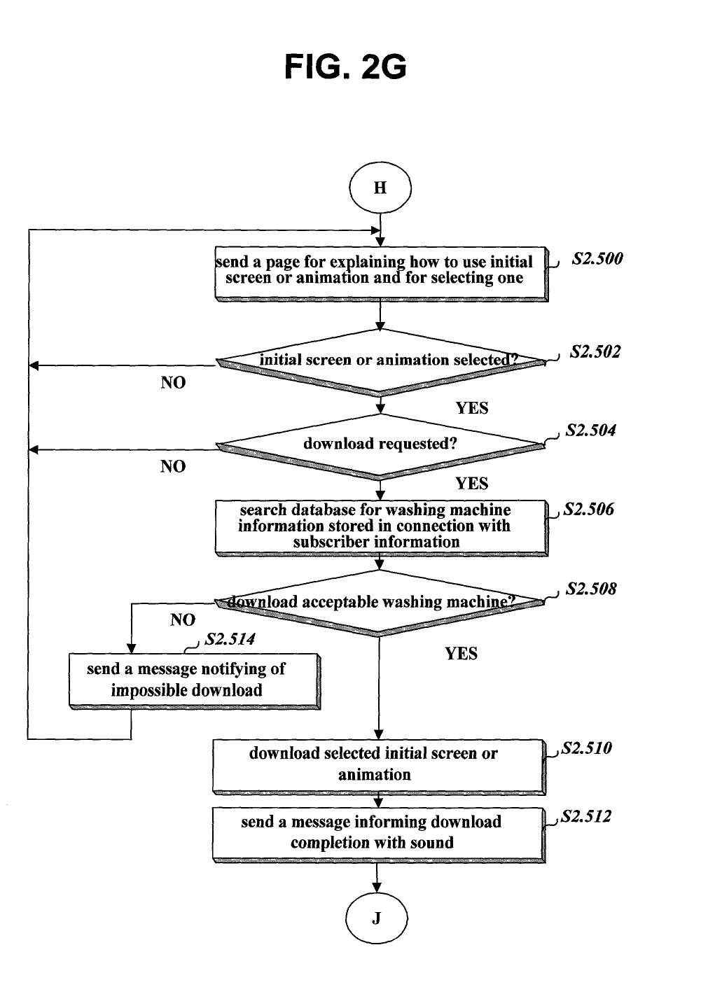

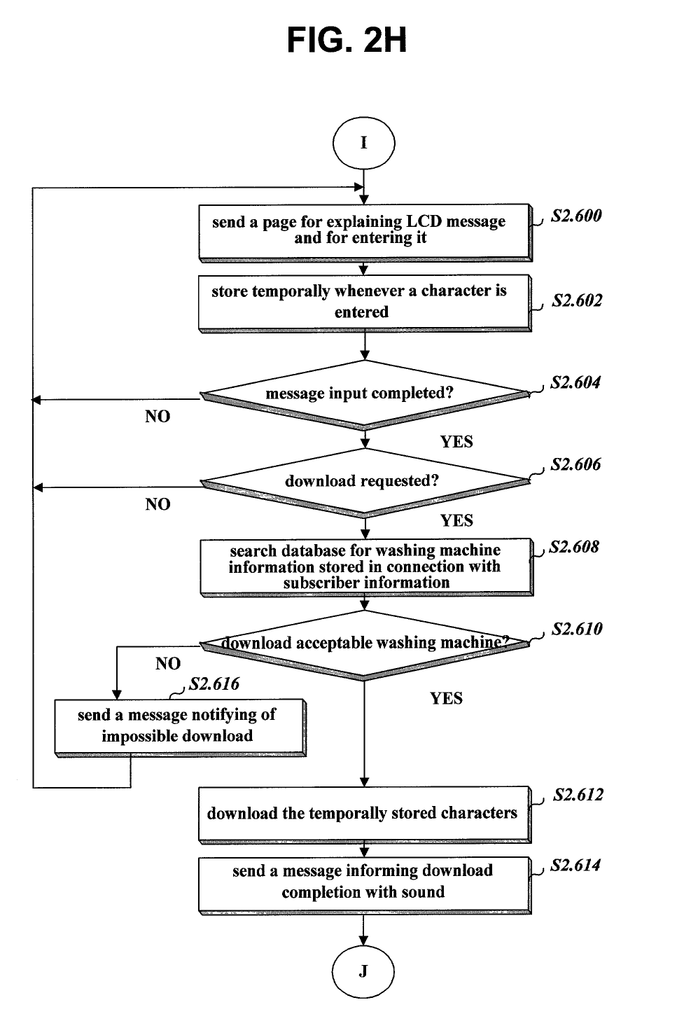

FIGS. 2A to 2H are flow charts showing a method of providing washing course program from an Internet server in accordance with the present invention. The flow of FIG. 2A is explained first.

The PC 20₁ is connected to the IP server 20 through Internet 100 (S2.10), then, the IP server 10 checks whether a commercial Web browsing program such as ‘Explorer’ and ‘Netscape’ or the aforementioned IOP is connected (S2.12).

The IOP sends ‘is_iop.html’ containing session variable ‘ss_is_iop’=1 to the IP server 10 as soon as it is connected, therefore, the IP server 10 can ascertain that an IOP is connected if received data is indicative of ‘ss_is_iop’=1.

In addition, the IP server 10 also checks whether or not the connected IOP is latest version (S2.14). To identify version of the IOP, an additional variable may be used in html document.

In the checking process, if it is detected that not IOP but commercial Web browsing program is connected or an IOP of not latest version is connected, the IP server 10 sends graphic data guiding installation of an upgraded IOP (S2.100) according to the procedures depicted in FIG. 2B.

After sending the upgrade requesting graphic data, if download of the IOP of latest version is requested from the PC 20₁ (S2.102), the IP server 10 downloads the installation program into the selected or created folder, which an installation program for the newest IOP is downloaded into, selected or created by a user (S2.110). After that, a PC user or the IP server 10 remotely executes the downloaded installation program (S2.112), then, the installation program downloads the IOP of latest version, installs it in the PC 20₁, and outputs a message notifying of installation done (S2.114).

If execution of the IOP of latest version is requested directly without download request (S2.104), the IP server 10 selects or creates a temporary folder which an installation program for the newest IOP is downloaded into, downloads the installation program into the selected or created temporary folder (S2.106), executes the downloaded installation program (S2.108). Then, the installation program downloads the IOP of latest version, installs it in the PC 20₁, and outputs a message notifying of installation completion (S2.114).

After the installation is done, the IP server 10 checks whether the data path to the PC 20₁ is re-set up by the installed IOP of latest version (S2.116). If the installed IOP sets up a data path again, the IP server 10 constitutes or pops up a login window (S2.16) according to procedures depicted in FIG. 2A. If data entered through the login window is received from the PC 20₁ (S2.18), the IP server 10 checks whether the entered data, namely, ID and password are valid (S2.20). If valid, the IP server 10 sends a html menu page for selecting various remote services it can provide.

Otherwise, the IP server 10 sends a html page for informing of invalid login data and guiding registration of a subscriber (S2.200) according to procedures depicted in FIG. 2C. If subscription is requested (S2.202), the IP server 10 sends anther html page containing a subscription agreement, and then receives an approval or denial data through the PC 20₁. If receiving an approval, the IP server 10 allocates a subscriber ID and password thereof. In this subscribing process, subscriber information including name, personal identification number, address, and information on a purchased washing machine is provided for the IP server 10, then, the IP server 10 stores the received subscriber information (S2.206).

The information on a purchased washing machine includes a model number of a purchased washing machine, and store and date where and when he or she purchased a washing machine.

After storing subscriber information, the IP server 10 re-checks whether there is washing machine information in the entered subscriber information (S2.208), and if there is not, it sends again a html page for entering information on a purchased washing machine as well as message requesting washing machine information (S2.210).

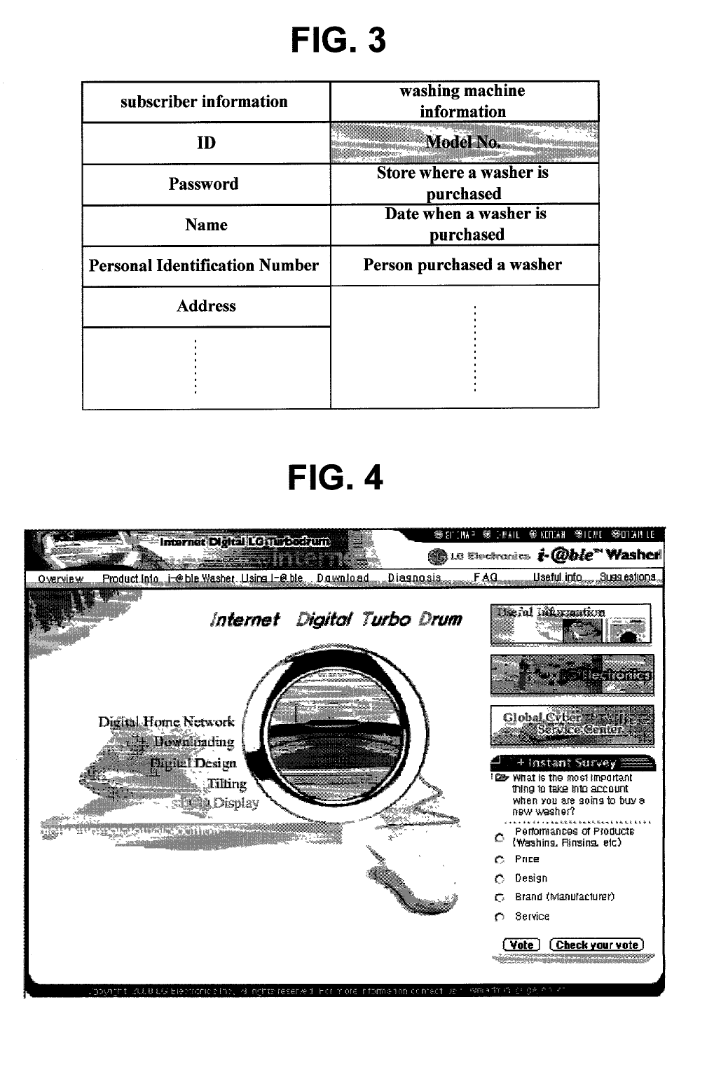

If the washing machine information is entered, the IP server 10 receives it (S2.212), and stores it in connection with the subscriber information stored before (S2.214) as shown in FIG. 3.

The stored model number or manufacture number is used for identifying whether a washing machine concerned is able to communicate with an IP server and to accept various washing course programs.

After the above procedures are done, a user confirms through the PC 20₁ a menu page for selecting a desired service the IP server 10 can provide. If a user selects a ‘download’ item with the PC 20₁ according to procedures depicted in FIG. 2D, the IP server 10 receives data indicative of ‘download’ selection (S2.24). After that, the IP server 10 receives a sub-item according to selection of a user from a provided sub-menu page. For example, if a selected sub-item is ‘Internet washing course’ (S2.26), the IP server 10 sends a html page for informing various washing courses, stored in its database, adequate to different washing conditions, and for selecting a desired washing course program (S2.300), according to procedures depicted in FIG. 2E.

The various washing courses according to different washing conditions may be ‘infant clothes’, ‘hand washing’, ‘washing+spinning’, ‘socks’, and ‘small load’.

Among these various washing courses, if a user selects one item and requests its download (S2.302,S2.304), the IP server 10 searches its database for a connected subscriber information (S2.306) first, and examines the washing machine information linked with the found subscriber information to check whether or not a washing machine, whose information has been obtained, is able to accept a washing course program to be downloaded (S2.308).

If the washing machine concerned has remote washing course updating function, the IP server 10 transmits the selected washing course program to the connected PC 20₁ (S2.312), then the transmitted washing course program is delivered to the washing machine 40 connected to the PC 20₁ through the communication cable 40, e.g., RS-232C serial cable or a modem, and it is updated in the washing machine 40. When the download is completed, the IP server 10 sends a message informing download completion (S2.314).

If the washing machine concerned has not remote washing course updating function, namely, it is old-fashioned one, the IP server 10 sends a message notifying of impossible download to the PC 20₁ (S2.310).

If a sub-item of ‘My favorite course’ is selected on the download main menu (S2.28), the IP server 10 sends a html page for explaining ‘my favorite course’ program and for selecting washing conditions he or she wants (S2.400), according to procedures depicted in FIG. 2F. In the selectable washing conditions, parameters on washing, rinsing, and spinning time, water temperature, water level, and water whirls may be set.

While parameters are being set one by one, the IP server 10 stores the parameters temporally (S2.402), and if download of his or her setting favorite course program is requested after all parameters are set (S2.404), the IP server 10 searches its database for a connected subscriber information (S2.408) as explained above, and examines the washing machine information linked with the found subscriber information to check whether or not a washing machine is able to accept a favorite washing course program to be downloaded (S2.410).

If it is determined that the washing machine concerned is able to accept washing course programs from a remote server, the IP server 10 transmits the favorite washing course program reflecting the set parameters to the connected PC 20₁ (S2.412), then the transmitted favorite washing course program is delivered to the washing machine 40 connected to the PC 20₁ through the communication cable 40 and is stored. When the download is completed, the IP server 10 sends a message informing download completion (S2.414).

If the washing machine concerned is old-fashioned so that it can not accept a washing course program, the IP server 10 sends a message notifying of impossible download to the PC 20₁ (S2.416).

If a sub-item of ‘initial screen’ or ‘animation’ is selected on the download main menu (S2.30), the IP server 10 sends a html page for showing various initial screens or animations, namely, moving graphics representing washing states and for selecting favorite one (S2.500) after reading them from its database, according to the procedures depicted in FIG. 2G.

If a user selects one item among various initial screens or animations and requests its download (S2.502,S2.504), the IP server 10 searches its database for information of a connected subscriber (S2.306) first, and examines the washing machine information linked with the found subscriber information to check whether or not a washing machine is able to accept initial screen or animations to be downloaded (S2.508).

If the model number or manufacture number is for a washing machine being able to accept remote washing course programs, the IP server 10 transmits the chosen initial screen or animations to the connected PC 20₁ (S2.510), then the transmitted initial screen data or animation data is re-sent to the washing machine 40 connected to the PC 20₁ through the communication cable 40 and replaces previous one stored in the washing machine 40. When the download is completed, the IP server 10 sends a message informing download completion (S2.512)

If the washing machine concerned is an old-fashioned one not updateable, the IP server 10 sends a message notifying of impossible download to the PC 20₁ (S2.514).

If a sub-item of ‘LCD message setting’ is selected on the download main menu (S2.32), the IP server 10 sends a html page for explaining how to use LCD message and for entering message he or she wants (S2.600), according to the procedures depicted in FIG. 2H. According to instruction displayed on the html page, a user types-in a message he or she wants to express, for example, “I would like to give you my sincere love”. The IP server 10 stores the entered characters temporally (S2.602) while message is being entered. If message input is done (S2.604) and then download of the entered message is requested (S2.606), the IP server 10 searches its database for information of a connected subscriber (S2.608) and checks whether the found information indicates that washing machine is able to accept LCD message to be downloaded (S2.610).

If the model or manufacture number is for a washing machine being able to accept LCD message, the IP server 10 transmits the stored message to the connected PC 20₁ (S2.612), then the transmitted message is re-sent to the washing machine 40 connected to the PC 20₁ through the communication cable 40 and is stored as displaying message in the washing machine 40. When the download is completed, the IP server 10 sends a message informing download completion (S2.614).

If the washing machine concerned is an old-fashioned not being able to accept displaying message, the IP server 10 sends a message notifying of impossible download to the PC 20₁ (S2.616).

If a sub-item of ‘melody’ is selected on the download main menu (S2.34), the IP server 10 sends a html page for explaining how to use melody and for selecting melody he or she wants, according to the procedures depicted in FIG. 2D. According to instruction displayed on the html page, a user selects his or her favorite melody, then, the IP server 10 searches its database for information of a connected subscriber (S2.36) and checks whether the found information indicates that washing machine can accept melody data to be downloaded (S2.38).

If the model or manufacture number is for a washing machine being able to accept melody data, the IP server 10 transmits data of the chosen melody to the connected PC 20₁, then the transmitted melody data is re-sent to the washing machine 40 connected to the PC 20₁ through the communication cable 40 and is stored in the washing machine 40 as melody data sounding during washing time. When the download is completed, the IP server 10 sends a message informing download completion (S2.40).

If the washing machine concerned is an old-fashioned one not being able to replace sound data, the IP server 10 sends a message notifying of impossible download to the PC 20₁ (S2.42).

According to the above-explained embodiments, the washing machine can execute or update pre-defined washing course program, favorite washing course program, initial screen, animations, LCD message, melodies from the IP server 10. Therefore, washing machine manufacturing company can always provide already-sold washing machines with newly-developed functions with ease through updating database of the IP server.

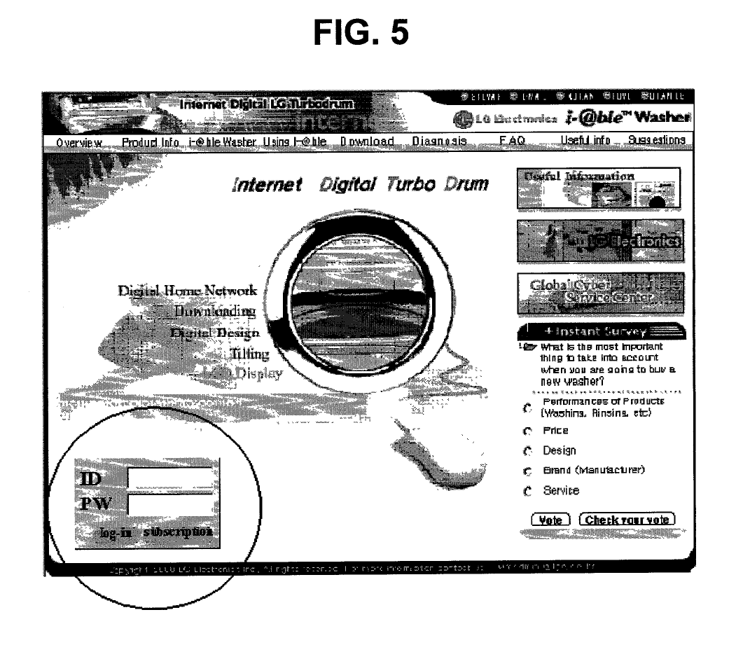

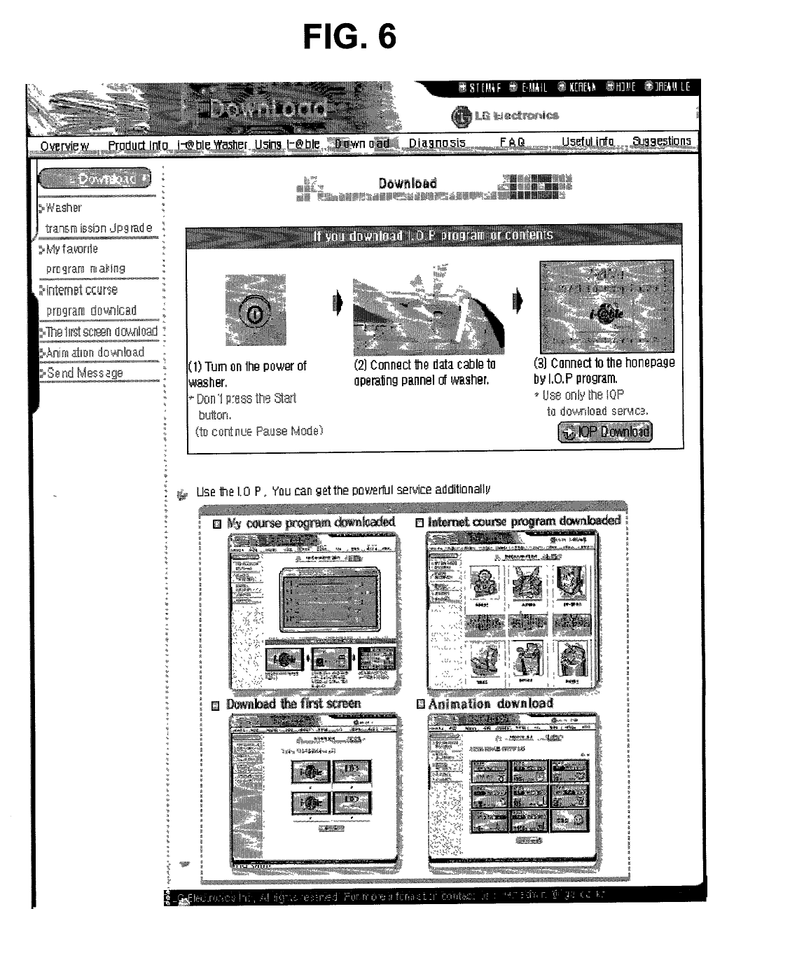

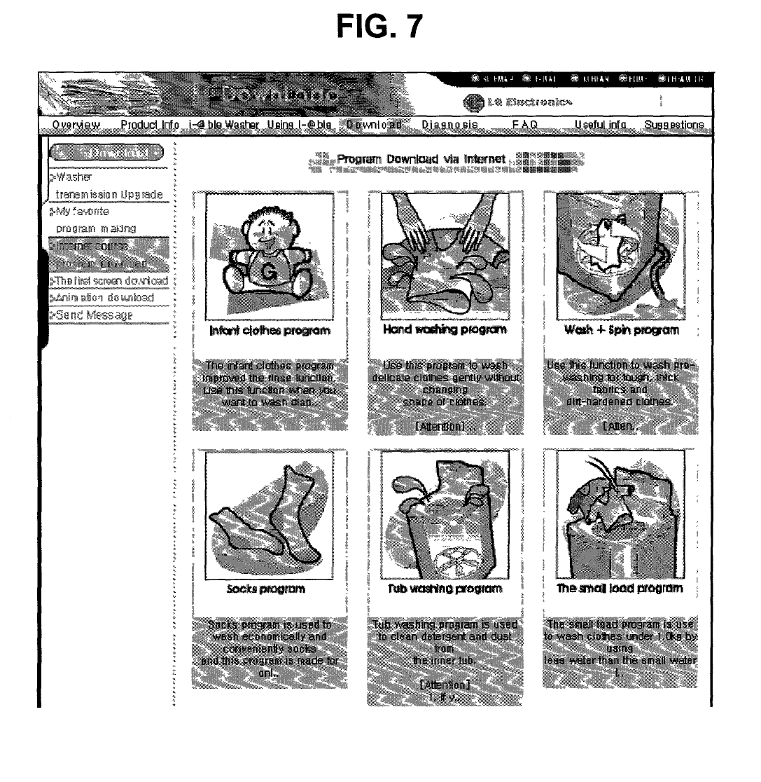

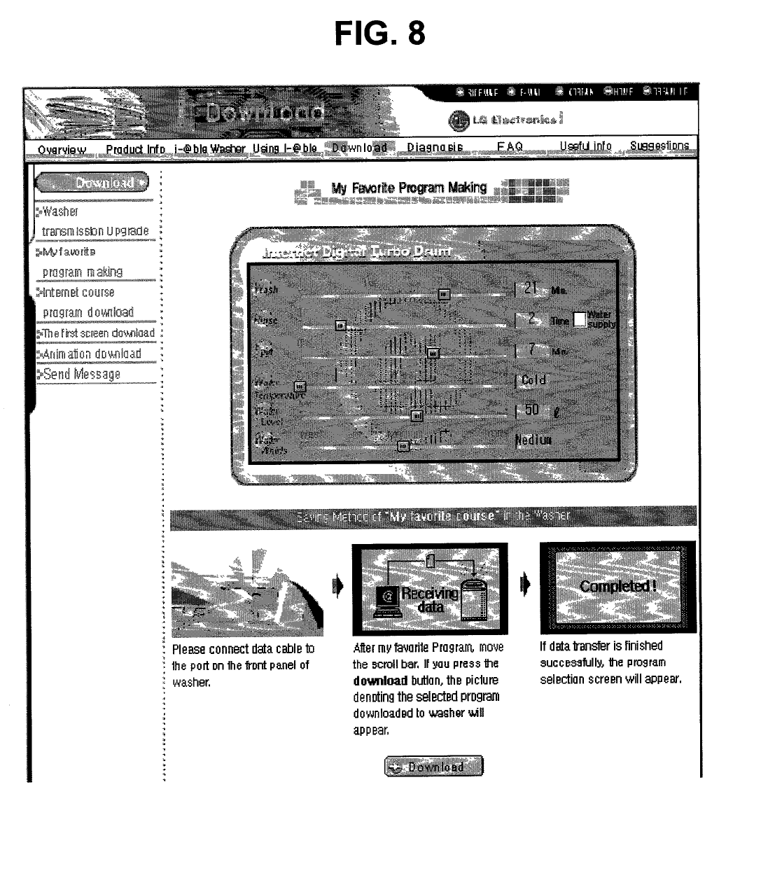

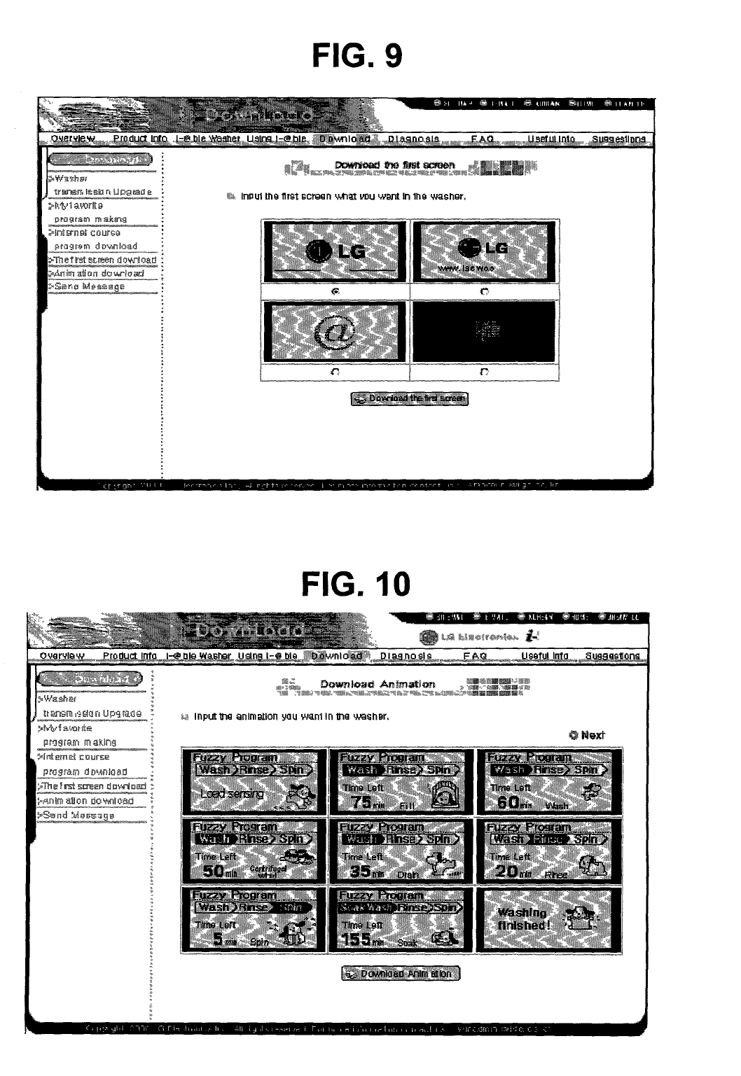

FIGS. 4 and 5 show examples of home page and login window of the IP server according to the present invention, respectively. FIG. 6 shows an example of a download menu page presented by the IP server, and FIGS. 7 to 10 show Internet washing course program selected sub-menu page, favorite washing course program selected sub-menu page, LCD message selected sub-menu page, and animation selected sub-menu page, respectively.

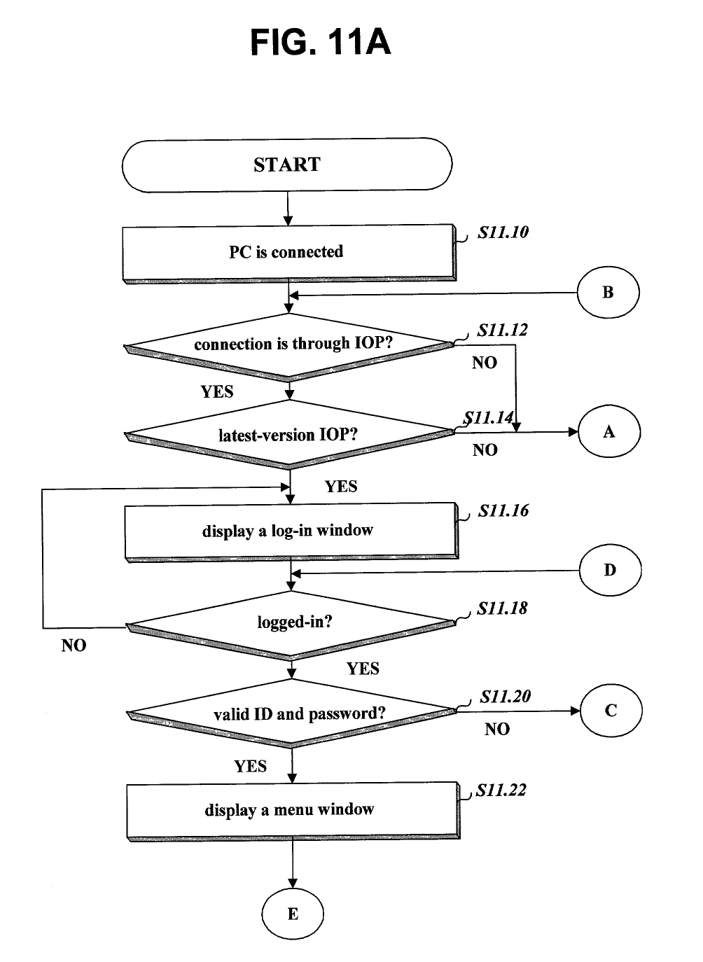

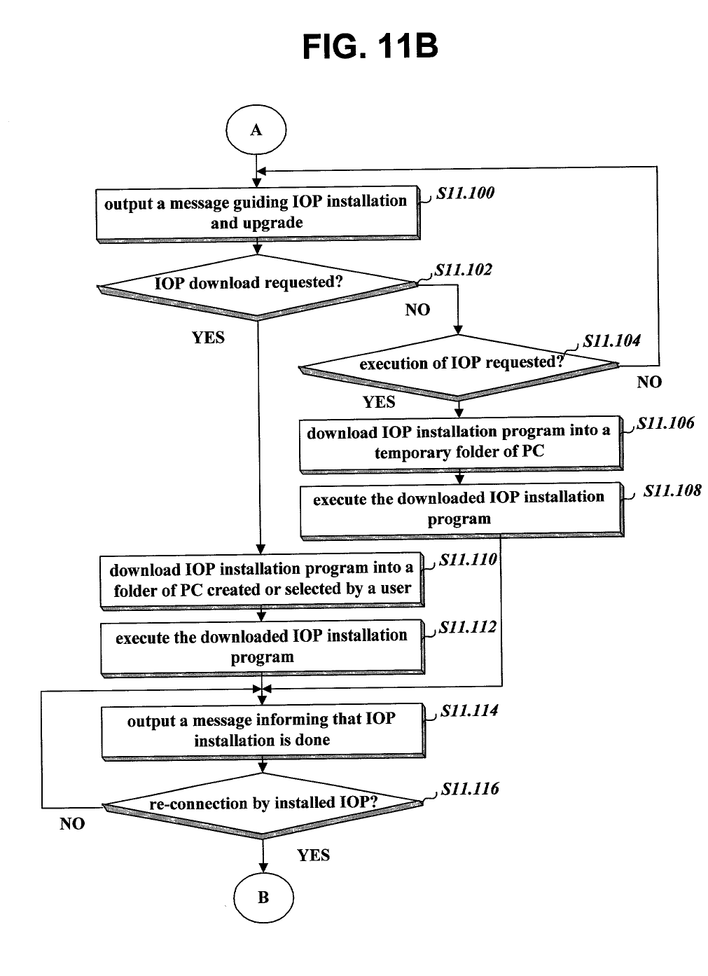

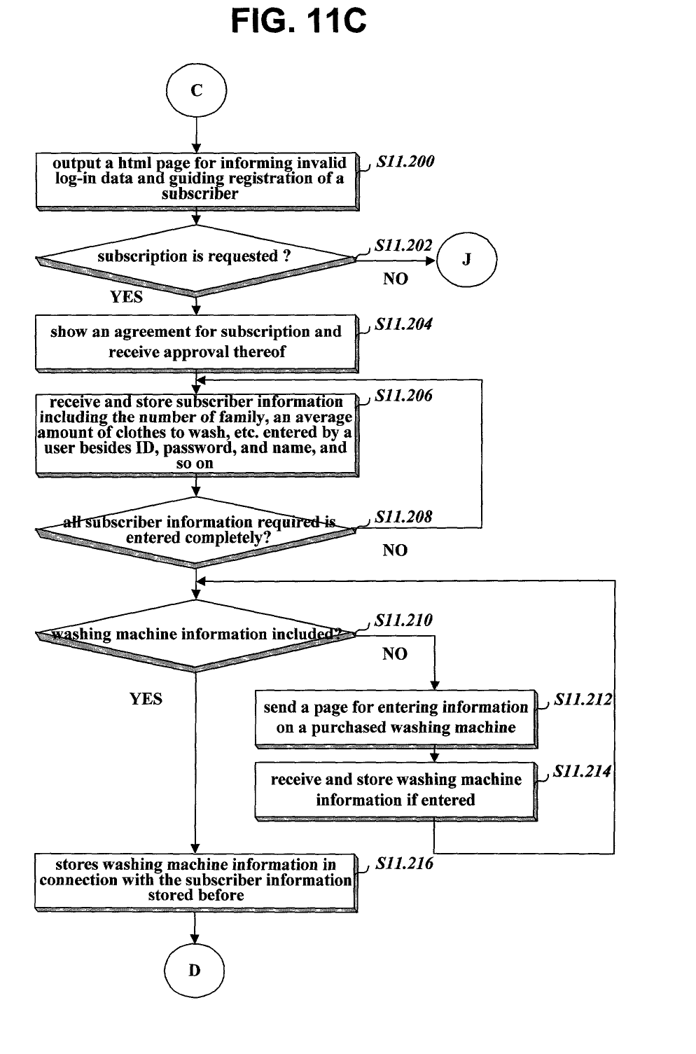

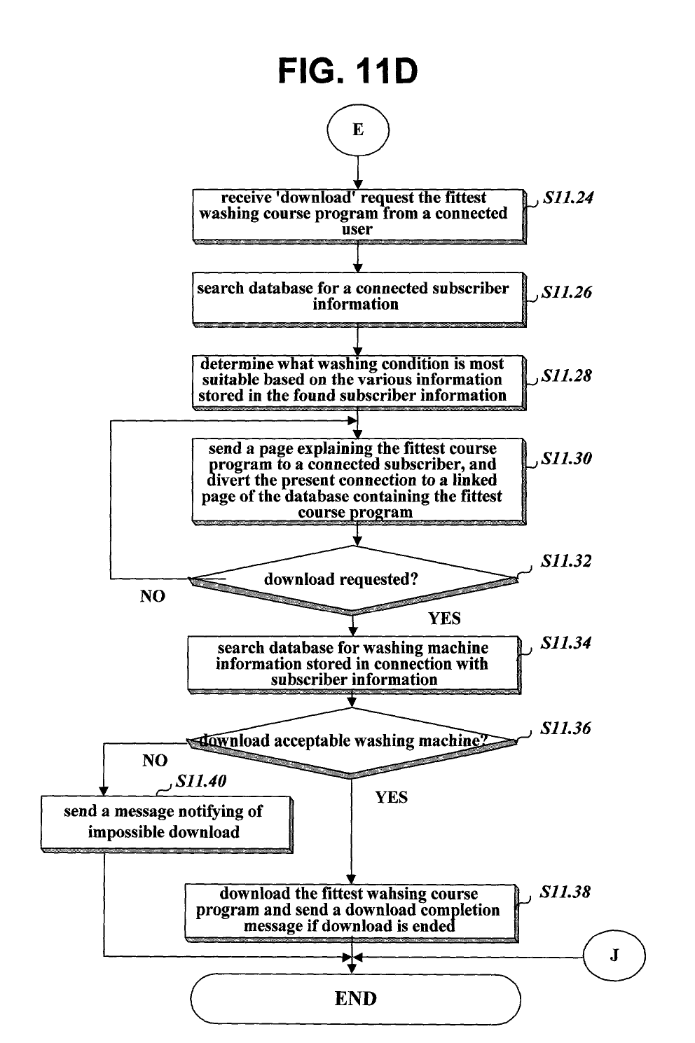

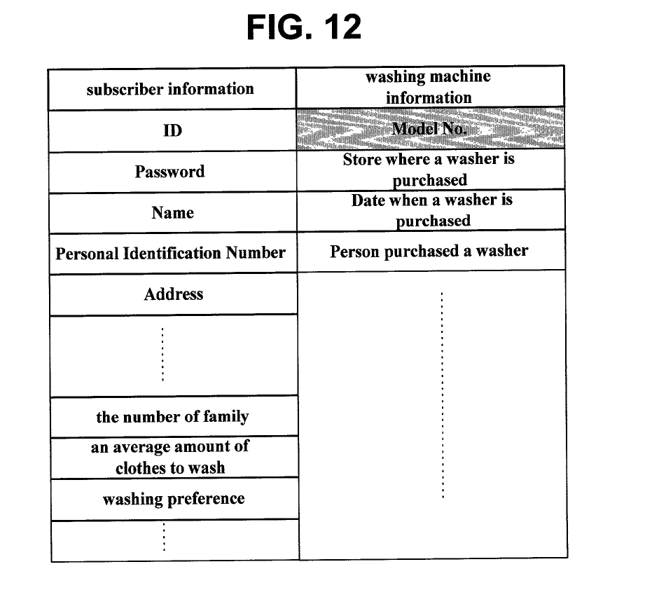

FIGS. 11A to 11D are flow charts showing a method of providing the fittest washing course program from an Internet server in accordance with the present invention. The flow of FIG. 11A is explained first.

The PC 20₁ is connected to the IP server 20 through Internet 100 (S11.10), then, the IP server 10 checks whether a commercial Web browsing program such as ‘Explorer’ and ‘Netscape’ or the aforementioned IOP is connected (S11.12).

The IOP sends ‘is_iop.html’ containing session variable ‘ss_is_iop’=1 to the IP server 10 as soon as it is connected, therefore, the IP server 10 can ascertain that IOP is connected if received data is indicative of ‘ss_is_iop’=1.

In addition, the IP server 10 also checks whether or not the connected IOP is latest version (S11.14). To identify version of the IOP, an additional variable may be used in a html document.

In the checking process, if it is detected that not IOP but commercial Web browsing program is connected or an IOP of not latest version is connected, the IP server 10 sends graphic data guiding installation of upgraded IOP (S11.100), according to the procedures depicted in FIG. 11B.

After sending upgrade requesting graphic data, if download of he IOP of latest version is requested from the PC 20₁ (S11.102), the IP server 10 downloads the installation program into the selected or created folder in the PC 20₁ by a user (S11.110). After that, a PC user executes the downloaded installation program (S11.112), then, the installation program downloads the IOP of latest version, installs it in the PC 20₁, and outputs a message notifying of installation done (S11.114).

If execution of the IOP of latest version is requested directly without download request (S11.104), the IP server 10 selects or creates a temporary folder which an installation program for the newest IOP is downloaded into, downloads the installation program into the selected or created temporary folder (S11.106), executes the downloaded installation program (S11.108). Then, the installation program downloads the IOP of latest version, installs it in the PC 20₁, and outputs a message notifying of installation done (S11.114)

After the installation is done, the IP server 10 checks whether the data path to the PC 20₁ is re-set up by the installed IOP of latest version (S11.116). If the installed IOP sets up a data path again, the IP server 10 displays or pops up a login window (S11.16), according to the procedures depicted in FIG. 11A. If data entered through the login window is received from the PC 20₁ (S11.18), the IP server 10 checks whether the entered data, namely, ID and password are valid (S11.20). If valid, the IP server 10 sends a html menu page for selecting various remote services it can provide.

Otherwise, the IP server 10 sends a html page for informing invalid login data and guiding registration of a subscriber (S11.200) according to procedures depicted in FIG. 11C. If subscription is requested (S11.202), the IP server 10 sends anther html page containing a subscription agreement, and then receives an approval or denial data through the PC 20₁. Receiving an approval, the IP server 10 allocates a subscriber ID and a password thereof, and sends a subscription window to the PC 20₁(S11.206). In this subscribing process, subscriber information including name, personal identification number, address, information on a purchased washing machine, the number of family, average amount of clothes to wash, washing preference about major type of clothes, whether to use bleaching agent, frequently-using washing/spinning way, and so on is provided for the IP server 10, then, the IP server 10 stores the received subscriber information (S11.208).

The information on a purchased washing machine may be about model number or manufacturing number of a washing machine, and store and date where and when he or she purchased a washing machine.

After storing subscriber information, the IP server 10 re-checks whether there is washing machine information in the entered subscriber information same with the entered one (S11.210), and if there is not, it sends again a html page for entering information on a purchased washing machine as well as message requesting washing machine information or indicating incorrect information (S11.212).

If correct washing machine information is entered due to the informative message, the IP server 10 receives and stores it in connection with the subscriber information stored before (S11.214) as shown in FIG. 3.

The stored model or manufacture number is used for checking whether a washing machine concerned is able to communicate with an IP server and to accept various washing course programs.

After the above procedures are done, a user confirms through the PC 20₁ a menu page for selecting a desired service the IP server 10 can provide. If a user selects a ‘fittest washing course’ item with the PC 20₁ according to the procedures depicted in FIG. 11D, the IP server 10 receives data indicative of ‘fittest washing course’ item selection (S11.24). After that, the IP server 10 searches its database for information of a connected subscriber, first (S11.26), and determines what washing condition is most suitable based on the various information entered at the time of subscription (S11.28), namely, the number of family, an average amount of clothes to wash, washing preference about major type of clothes, whether to use bleaching agent, frequently-using washing/spinning way, and so on.

To determine the most suitable washing course, the IP server 10 searches its database containing many various optimal washing course programs for the closest course program to the entered condition. If it is found, the IP server 10 sends a html page explaining the fittest course program to a connected subscriber, and diverts the present connection to a linked page of the database containing the closest course program (S11.30).

If a user requests download of the fittest course program by clicking a corresponding linked string (S11.32), the IP server 10 searches its database for information of a connected subscriber (S11.34), and examines the washing machine information linked with the found subscriber information to check whether or not a washing machine is able to accept washing course program provided from remote (S11.36).

If the model or manufacture number contained in subscriber information is for a washing machine being able to accept a washing course program, the IP server 10 transmits the determined washing course program to the connected PC 20₁, then the transmitted washing course program is re-sent by running IOP to the washing machine 40 connected to the PC 20₁ through the communication cable 40, and is stored in the washing machine 40. When the download is completed, the IP server 10 sends a message informing download completion (S11.38).

If the washing machine concerned is an old-fashioned one not being able to accept washing course program, the IP server 10 sends a message notifying of impossible download to the PC 20₁ (S11.40).

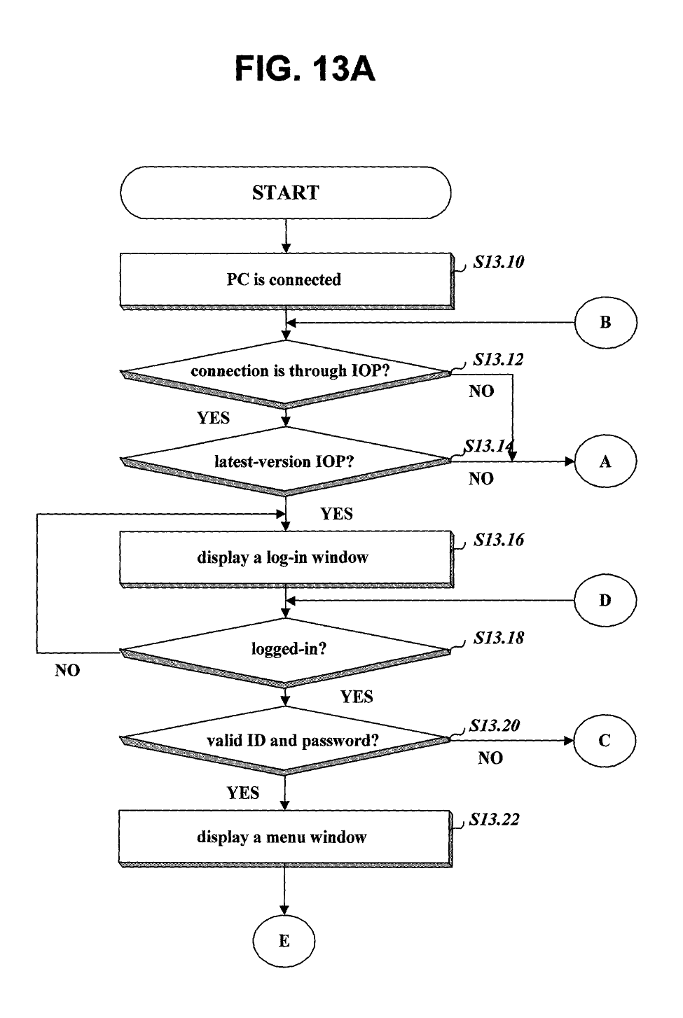

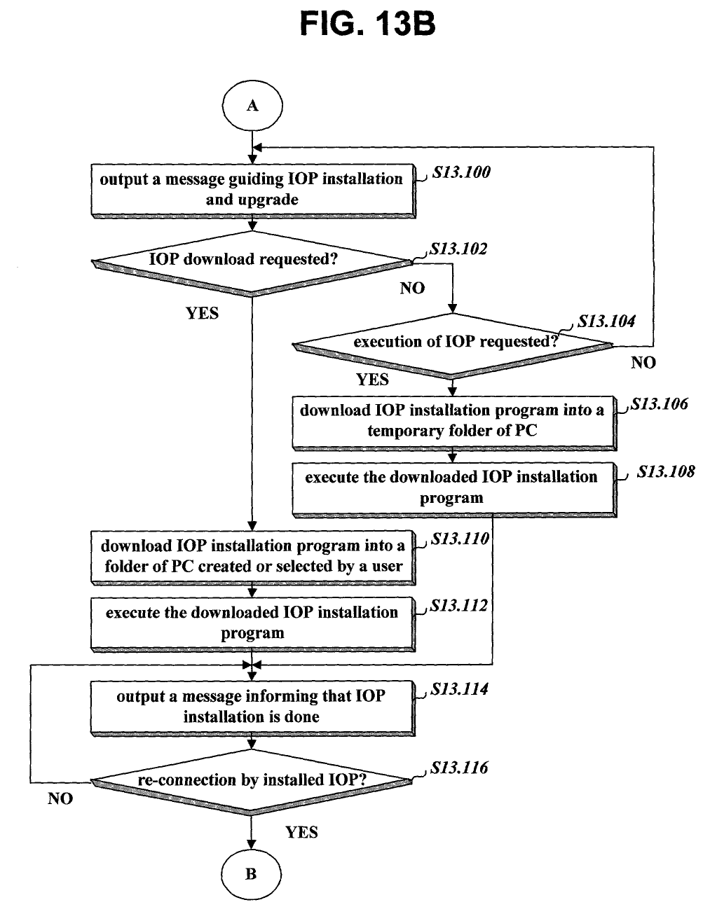

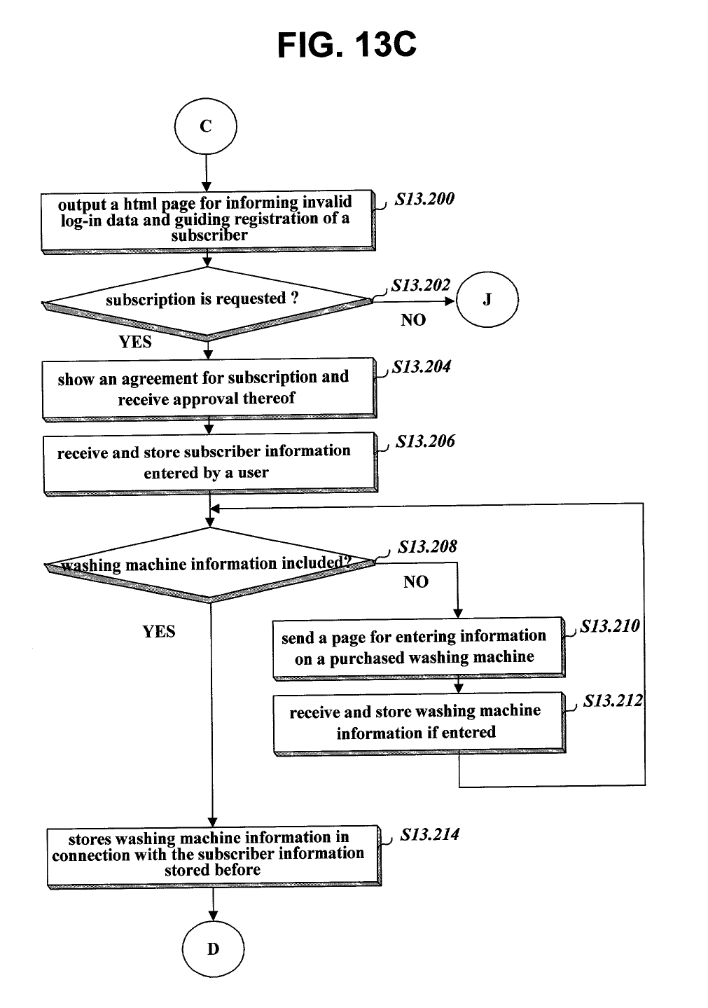

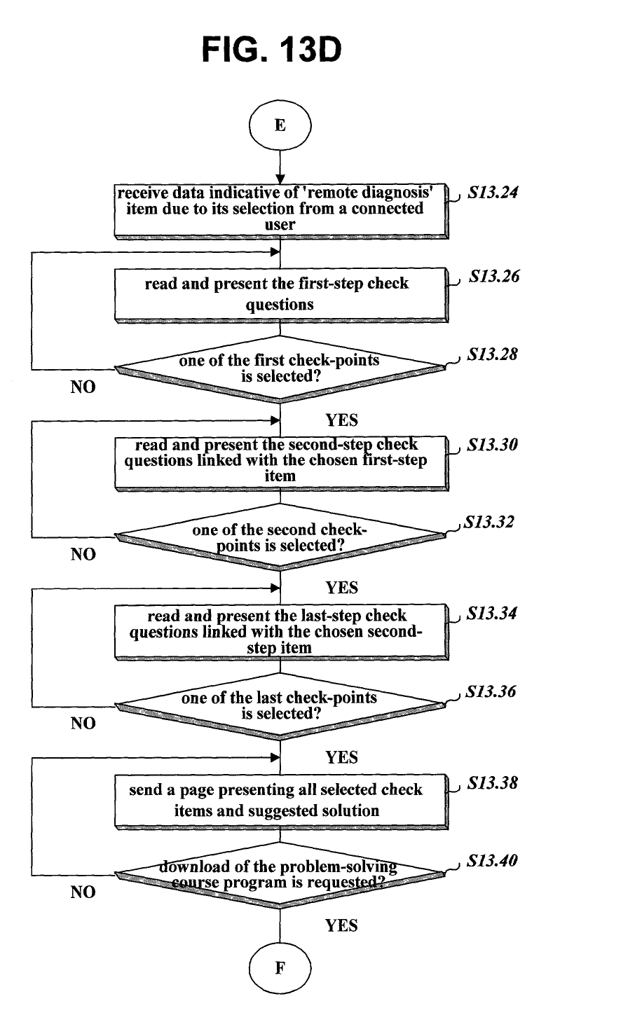

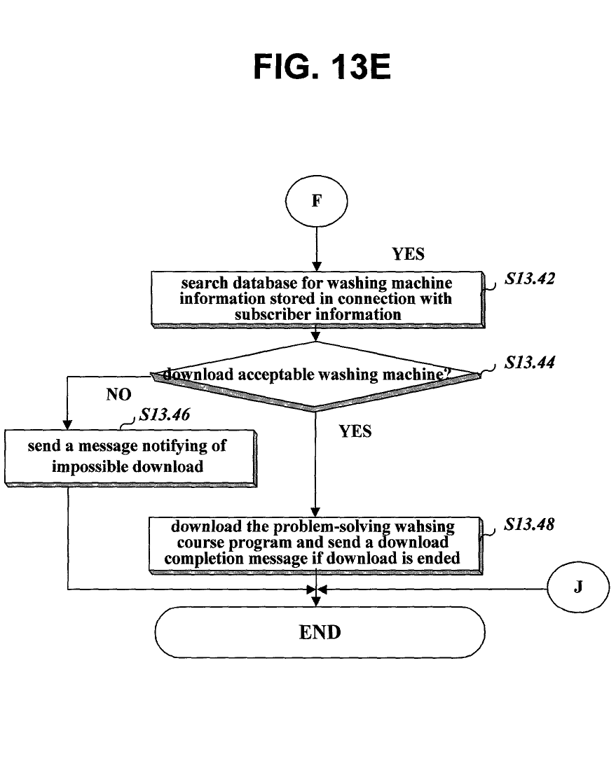

FIGS. 13A to 13E are flow charts showing a method of providing a remote diagnosis service from an Internet server in accordance with the present invention. The flow of FIG. 13A is explained first.

The PC 20₁ is connected to the IP server 10 through Internet 100 (S13.10), then, the IP server 10 checks whether a commercial Web browsing program such as ‘Explorer’ and ‘Netscape’ or the aforementioned IOP is connected (S13.12).

The IOP sends ‘is_iop.html’ containing session variable ‘ss_is_iop’=1 to the IP server 10 as soon as it is connected, therefore, the IP server 10 can ascertain that IOP is connected if received data is indicative of ‘ss_is_iop’=1.

In addition, the IP server 10 also checks whether or not the connected IOP is latest version (S13.14). To identify version of the IOP, an additional variable may be used in a html document.

In the checking process, if it is detected that not IOP but commercial Web browsing program is connected or an IOP of not latest version is connected, the IP server 10 sends graphic data guiding installation of upgraded IOP (S13.100), according to the procedures depicted in FIG. 13B.

After sending upgrade requesting graphic data, if download of the IOP of latest version is requested from the PC 20₁ (S13.102), the IP server 10 selects or creates a download folder which an installation program for the newest IOP is downloaded into, first, and downloads the installation program into the selected or created folder (S13.110) After that, a PC user executes the downloaded installation program (S13.112), then, the installation program downloads the IOP of latest version, installs it in the PC 20₁, and outputs a message notifying of installation done (S13.114).

If execution of the IOP of latest version is requested directly without download request (S13.104), the IP server 10 selects or creates a temporary folder which an installation program for the newest IOP is downloaded into, downloads the installation program into the selected or created temporary folder (S13.106), executes the downloaded installation program (S13.108). Then, the installation program downloads the IOP of latest version, installs it in the PC 20₁, and outputs a message notifying of installation done (S13.114).

After the installation is done, the IP server 10 checks whether the data path to the PC 20₁ is set up again by the installed IOP of latest version (S13.116). If the installed IOP sets up a data path, the IP server 10 displays or pops up a login window (S13.16), according to the procedures depicted in FIG. 13A. If data entered through the login window is received from the PC 20₁ (S13.18), the IP server 10 checks whether the entered data, namely, ID and password are valid (S13.20). If valid, the IP server 10 sends a html menu page for selecting various remote services it can provide.

If the entered ID and password are not valid, the IP server 10 sends a html page for informing invalid login data and guiding subscriber registration (S13.200), according to procedures depicted in FIG. 13C. If subscription is requested (S13.202), the IP server 10 sends anther html page containing a subscription agreement, and then receives an approval or denial data through the PC 20₁. Receiving an approval, the IP server 10 allocates a subscriber ID and a password thereof, and sends a subscription window to the PC 20₁. In this subscribing process, subscriber information including name, personal identification number, address, information on a purchased washing machine, and so on is provided for the IP server 10, then, the IP server 10 stores the received subscriber information (S13.206).

After storing subscriber information, the IP server 10 checks whether there is washing machine information in the entered subscriber information same with the entered one (S13.208), and if there is not, it sends again a html page for entering information on a purchased washing machine as well as message requesting washing machine information or indicating incorrect information (S13.210).

If correct washing machine information is entered due to the informative message, the IP server 10 receives (S13.212) and stores it (S13.214) in connection with the subscriber information as shown in FIG. 3.

The stored model or manufacture number is used for checking whether a washing machine concerned is able to communicate with the IP server and to accept various washing course programs.

After the above procedures are done, a user confirms through the PC 20₁ a menu page for selecting a desired service the IP server 10 can provide. If a user selects a ‘remote diagnosis’ item with the PC 20₁ according to the procedures depicted in FIG. 13D, the IP server 10 receives data indicative of ‘remote diagnosis’ item selection (S13.24). After that, the IP server 10 conducts remote self diagnosis step by step as follows.

The IP server 10 reads the first-step check questions from database and presents them onto the PC 20₁ (S13.26). The first-step check questions may be problem overview like as ‘light washing ability’ or “Do you want less damage to fabrics?”

If one item is chosen in the first-step check list (S13.28), the IP server 10 reads the second-step check points linked with the chosen first-step item from the database, and sends them to the PC 20₁ to show to a user (S13.30). The linked second-step check points list up possible reasons why the chosen first-step problem happens.

For example, if the chosen first-step item is ‘light washing ability’, one of the second-step check points may be a sentence of “Did you select water level properly?” The others may be “Did you select washing program properly?” or “Is there a stain in washed clothes?”

If one item is chosen in the second-step check list (S13.32), the IP server 10 reads the third-step check points linked with the chosen second-step item from the database, and sends them to the PC 20₁ to show to a user (S13.30). The linked third-step check points also list up possible reasons why the chosen second-step problem happens.

For example, if the selected second-step item is “Did you select water level properly?”, one of the third-step check points may be “Did you select water level too high or low?”. The others may be “Did you input clothes additionally after pressing start/pause button?”, etc.

If one item is chosen among the third-step items by a user, the IP server 10 reads a suggestion, stored in the database in connection with the selected item, to solve the chosen problem, and sends a user a html page presenting all selected check items and suggested solution (S13.38).

If a user selects a diagnosis item of ‘light washing ability’ at the first step, “Do you select water level properly?” at the second step, and “Did you select water level too high or low?” at the last step, the IP server 10 suggests a solution like ‘Control water level properly’ to the user with selected problem check items.

In addition, a washing course program to solve problems given at the above diagnosing procedures can be downloaded to a washing machine. For example, if the reason of ‘light washing ability’ is that clothes to wash are blue jeans, the IP server 10 suggests download of blue jeans washing course program to a user and then diverts the present connection to a linked page of the database containing the problem solving washing program.

If a user requests download of the problem-solving course program by clicking the given linked string (S13.40), the IP server 10 searches its database for information of a connected subscriber, and checks whether or not a washing machine is able to accept washing course program provided from remote (S13.42) in the basis of the subscriber information.

If the model or manufacture number contained in the subscriber information is indicative of a washing machine being able to accept a washing course program (S13.44), the IP server 10 transmits the determined washing course program to the connected PC 20₁, then the transmitted washing course program is re-sent by running IOP to the washing machine 40 connected to the PC 20₁ through the communication cable 40, and is stored in the washing machine 40. When the download is completed, the IP server 10 sends a message informing download completion (S13.48).

If the washing machine concerned is an old-fashioned one not being able to accept a washing course program, the IP server 10 sends a message notifying of impossible download to the PC 20₁ (S13.46).

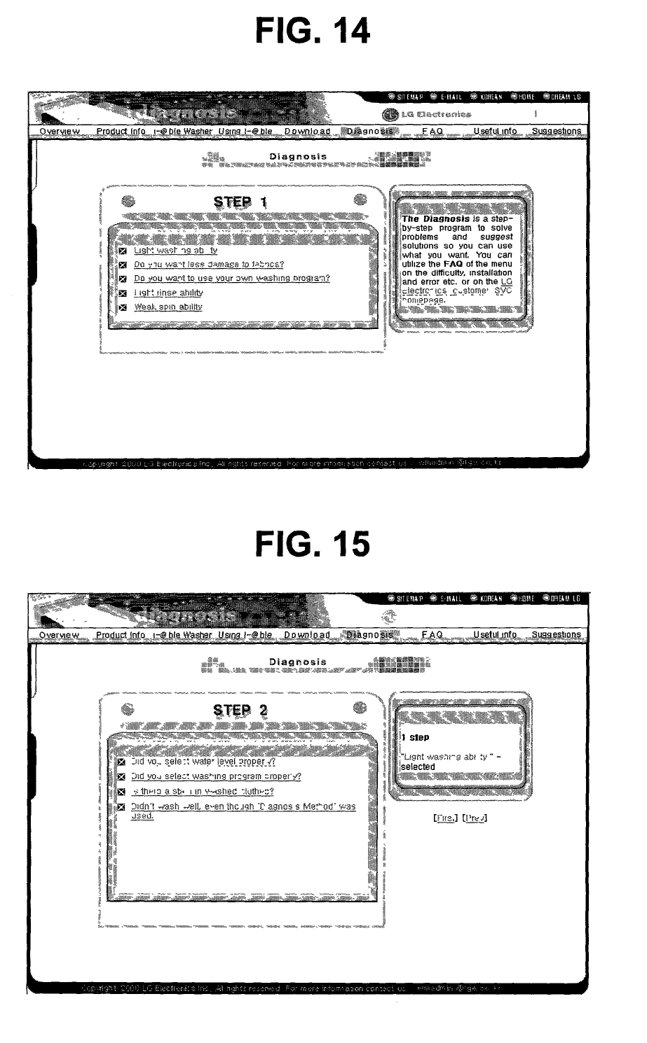

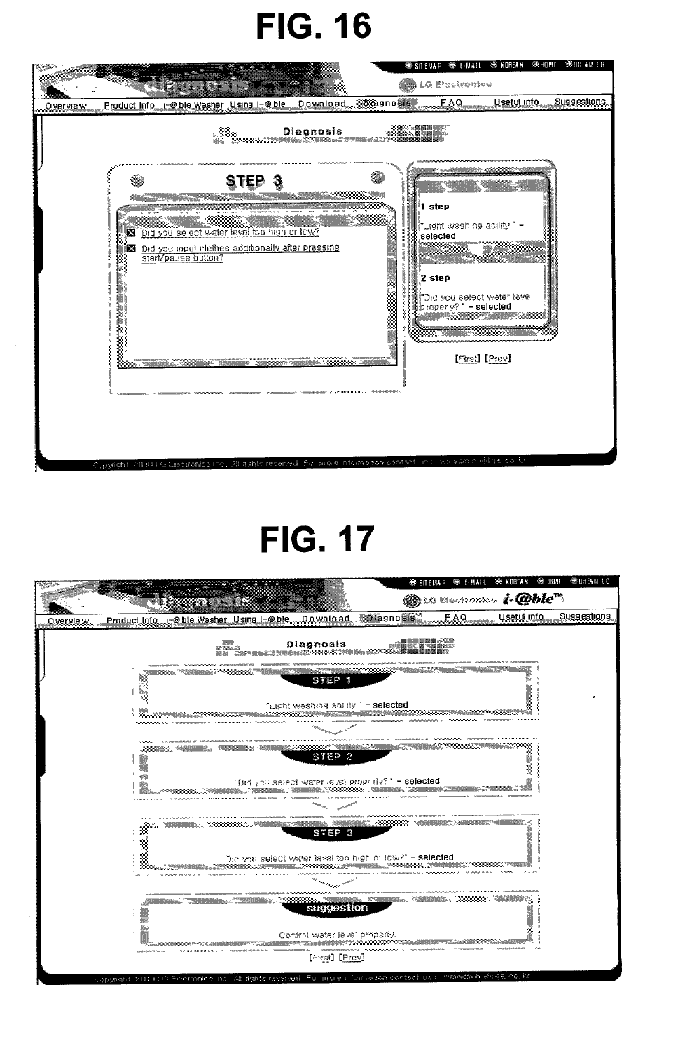

FIGS. 14 to 17 show exemplary menu screens for each step conducted according to the above-explained diagnosing procedures in accordance with the present invention.

The method of providing various washing course programs and/or self diagnosis of an automatic washer remotely from an Internet server in accordance with the present invention, can apply newly-developed various washing course programs to already-sold washing machines with ease, make it possible for a user to set and change initial screen displayed onto an LCD, animations indicating washing states, messages to deliver to someone through an LCD, melodies as he or she wants, and prevent damages of clothes, light washing ability, and so on which might be caused from unskilled manipulation to a washing machine.

The invention may be embodied in other specific forms without departing from the sprit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A method of providing a washing course program from a server, comprising the steps of:
(a) checking whether a pre-determined network communication program has been installed in a subscriber data terminal connected through a data network;
(b) advising of an installation of the pre-determined network communication program and downloading the pre-determined network communication program in the basis of the checking result;
(c) displaying menu screen for selecting a washing course program stored in a database onto a monitor of the subscriber data terminal after executing the downloaded network communication program; and
(d) downloading a washing course program chosen from the subscriber data terminal to a washing machine through the subscriber data terminal connected with the washing machine.

2. The method set forth in claim 1, wherein the pre-determined network communication program conducts both Internet browsing function and data interfacing function between the subscriber data terminal and the washing machine.

3. The method set forth in claim 1, wherein said step (a) checks communication program identification code provided from the subscriber data terminal when the subscriber data terminal is connected in order to know whether a pre-determined network communication program has been installed in a connected subscriber data terminal.

4. The method set forth in claim 1, wherein said step (b) downloads the network communication program of latest version stored in the database into the connected subscriber data terminal, if the network communication program has not been installed or the network communication program of old version has been installed.

5. A method of providing a washing course program from a server, comprising the steps of:
(a) receiving transmission request of a washing course program stored in a database from a data terminal of a subscriber connected through a data network;
(b) examining washing machine information stored in connection with the connected subscriber; and
(c) downloading a washing course program chosen from the data terminal into a washing machine through the data terminal connected with the washing machine, in the basis of the examined washing machine information.

6. The method set forth in claim 5, wherein the washing course program has different washing, rinsing, or spinning time according to type of clothes and/or an amount of clothes to wash.

7. The method set forth in claim 5, wherein the washing machine information includes information identifying whether a washing course program to be downloaded through the data network is acceptable or not.

8. The method set forth in claim 7, wherein the identifying information includes a model number or an unique manufacture number.

9. The method set forth in claim 5, wherein said step (c) sends a message announcing that download can not be conducted if the examined washing machine information indicates that the washing machine connected to the data terminal is not able to accept the transmission requested washing course program.

10. A method of providing a washing course program from a server, comprising the steps of:
(a) composing a washing course program whose parameters are set from washing conditions specified sequentially from a subscriber data terminal connected through a data network;
(b) receiving download request of the composed washing course program from the subscriber data terminal; and
(c) downloading the composed washing course program to a washing machine through the data terminal connected with the washing machine.

11. The method set forth in claim 10, wherein the washing conditions are specified sequentially from each selection on menu screens showing various washing conditions, the menu screens being displayed onto a monitor of the subscriber data terminal.

12. The method set forth in claim 10, wherein said step (c) examines washing machine information stored in connection with information of a connected subscriber, and downloads the composed washing course program to the washing machine if the examined washing machine information indicates that the washing machine connected to the data terminal is able to accept the composed washing course program.

13. A method of providing a washing course program from a server, comprising the steps of:
(a) displaying menu screen for selecting an initial screen or animation stored in a database onto a monitor of a subscriber data terminal connected through a data network;
(b) receiving transmission request of a chosen initial screen or animation from the subscriber data terminal; and
(c) downloading the chosen initial screen or animation to a washing machine through the data terminal connected with the washing machine.

14. The method set forth in claim 13, wherein said step (a) further displays menu screen for selecting melody of a washing machine stored in a database or entering text with the subscriber data terminal onto the monitor.

15. The method set forth in claim 14, wherein said step (c) further downloads the selected melody from the menu screen or the entered text through the menu screen to the washing machine through the data terminal.

16. A method of providing a washing course program from a server, comprising the steps of:
(a) examining washing conditions of a subscriber in the basis of subscriber information pre-stored in a database;
(b) searching the database for a washing course program suitable to the examined washing conditions; and
(c) displaying a message requesting download of the found suitable washing course program onto a monitor of a data terminal of the subscriber.

17. The method set forth in claim 16, wherein the washing conditions includes the number of the subscriber's family, an average amount of clothes to wash, or washing preference.

18. The method set forth in claim 16, wherein said step (c) further displays a page containing a linked text being able to divert connection to a site which can download the suitable washing course program.

19. The method set forth in claim 18, further comprising the step of: (d) downloading the suitable washing course program to a washing machine through the data terminal connected with the washing machine in the basis of washing machine information included in the subscriber information, if the linked text is clicked from the data terminal.

20. The method set forth in claim 19, wherein the washing machine information includes information identifying whether a washing course program to be downloaded through a data network is acceptable or not.

21. The method set forth in claim 20, wherein the identifying information includes a model number or an unique manufacture number.

22. The method set forth in claim 19, wherein said step (d) sends a message announcing that download can not be conducted if the washing machine information indicates that the washing machine connected to the data terminal is not able to accept the suitable washing course program.

23. A method of providing a self diagnosis service from a server, comprising the steps of:
(a) displaying menu screen for selecting washing machine diagnosing items for checking machine state and/or performance of subscriber's washing machine onto a monitor of a data terminal connected through a data network;
(b) receiving one or more items selected among the displayed washing machine diagnosing items through the data terminal;
(c) searching a database for a suggestion to solve the chosen items; and
(d) displaying the found suggestion onto the monitor.

24. The method set forth in claim 23, wherein the menu screen is provided sequentially from overview checking points to detailed.

25. The method set forth in claim 23, wherein the data terminal is running a network communication program being able to conduct both Internet browsing function and data interfacing function between the data terminal and a washing machine connected to the data terminal.

26. The method set forth in claim 23, wherein each suggestion is stored in connection with each washing machine diagnosing item set.

27. The method set forth in claim 23, wherein said step (d) displays the found suggestion with the selected washing machine diagnosing items onto the monitor.

28. A method of providing a self diagnosis service from a server, comprising the steps of:
(a) displaying step by step menu screens for selecting washing machine diagnosing items for checking machine state and/or performance of a subscriber's washing machine onto a monitor of a data terminal connected through a data network;
(b) receiving items selected on each menu screen step by step through the data terminal, and searching a database for a suggestion to solve the selected item set;
(c) determining a washing course program stored in connection with the found suggestion; and
(d) displaying a message requesting download of the determined washing course program onto the monitor.

29. The method set forth in claim 28, wherein said step (d) further displays a page containing a linked text being able to divert connection to a site which can download the determined washing course program.

30. The method set forth in claim 29, further comprising the step of: (e) downloading the determined washing course program to a washing machine through the data terminal connected with the washing machine in the basis of washing machine information stored in the database, if the linked text is clicked from the data terminal.

31. The method set forth in claim 30, wherein the washing machine information includes information identifying whether a washing course program to be downloaded through a data network is acceptable or not.

32. The method set forth in claim 31, wherein the identifying information includes a model number or an unique manufacture number.

33. The method set forth in claim 30, wherein said step (e) sends a message announcing that download can not be conducted if the washing machine information indicates that the washing machine connected to the data terminal is not able to accept the washing course program.
